(19) United States
(12) Patent Application Publication
(10) Pub. No.: US 2011/0274937 A1
(43) Pub. Date: Nov. 10, 2011

(54) LEAD-FREE SOLDER ALLOY, FATIGUE RESISTANT SOLDERING MATERIALS CONTAINING THE SOLDER ALLOY, AND JOINED PRODUCTS USING THE SOLDERING MATERIALS

(75) Inventors: Kenichiro Sugimori, Tokyo (JP); Seiji Yamada, Shiba (JP); Satoshi Kawakubo, Tokyo (JP); Atsushi Irisawa, Tokyo (JP)

(73) Assignees: KOKI COMPANY LIMITED, TOKYO (JP); KABUSHIKI KAISHA NIPPON FILLER METALS, NODA-CITY (JP)

(21) Appl. No.: 13/145,163

(22) PCT Filed: Jan. 18, 2010
(86) PCT No.: PCT/JP2010/050485

§ 371 Date: Jul. 19, 2011

(30) Foreign Application Priority Data
Jan. 27, 2009 (JP) 2009015087

(51) Int. Cl. B32B 15/04; B23K 35/34; C22C 13/00

(52) U.S. Cl. 428/457; 420/560; 148/24

(57) ABSTRACT

[PROBLEMS TO BE SOLVED] To provide a low-silver lead-free solder alloy having an excellent wettability and being excellent in heat-fatigue resistance, and a solder-paste soldering material and resin-flux cored soldering material being excellent in fatigue resistance, and a joined product by using the soldering material.

[MEANS FOR SOLVING] 0.1 to 1.5% by weight of Cu, 0.01% by weight or more and less than 0.05% by weight of Co, 0.05 to 0.25% by weight of Ag, 0.001 to 0.008% by weight of Ge, and the remainder being Sn. This low silver lead-free solder alloy is blended with a pasty flux or molded in a liner form by using a solid or pasty flux as a core.

[SELECTED FIGURE] FIG. 2

### TECHNICAL FIELD

The present invention relates to a lead-free solder alloy, a soldering materials containing the solder alloy excellent in fatigue resistance, and a joined product by soldering used for metal joining or the like of electric and electronic devices. More specifically, the present invention relates to a low-silver lead-free solder alloy used for reflow soldering, flow soldering, manual soldering or the like, a solder-paste soldering material and resin-flux cored soldering material that contains the lead-free solder alloy and is excellent in fatigue resistance, and a joined product using the soldering material.

### BACKGROUND ART

Conventionally, as solder alloys used for metal joining of electric and electronic devices, there have been usually used lead-containing solder alloys, for example, containing 63% by weight of Sn and 37% by weight of Pb.

With respect to the lead-containing solder, there has been pointed out that when lead eluted from wastes such as soldered circuit substrates permeates into ground water, such water causes serious health disorders in nervous system through drinking. From this point of view, many lead-free solder alloys without lead have been studied.

As lead-free solder alloys without lead, there have been studied SnCu-based alloys, SnAgCu-based alloys, SnBi-based alloys, SnZn-based alloys, alloys of SnAgCu-based alloys to which Bi, In, etc. are added, and the like.

Among them, the SnCu-based solder alloy, even when it is a eutectic alloy of Sn0.7Cu, has a higher melting point of 227° C. than the other lead-free solder alloys. However, the SnCu-based solder alloy is not fragile like SnBi-based alloys and is not inferior in erosion resistance in the case of SnZn-based alloys. Therefore, as materials being relatively excellent in wettability and low-cost, the SnCu-based solder alloy has been developed practically next to the SnAgCu-based alloys which are excellent in balance of wettability and strength.

However, when the Sn0.7Cu eutectic alloy is used for soldering in consideration of heat resistance of parts, the temperature difference between the melting point and processing temperature is compelled to become narrow. Accordingly, problems associated with soldering are easily caused, that is, the Sn0.7Cu eutectic alloy is inferior in wettability, and is inferior in fatigue resistance to SnAgCu-based solder such as Sn3Ag0.5Cu, which is an obstacle to the practical development of Sn—Cu-based alloys.

In order to improve the wettability and fatigue resistance of the SnCu-based alloys, there are proposed alloys in which a small amount of Ag, Bi, Ni, Si, Co, etc is added to the Sn0.7Cu eutectic alloy.

Although wettability can be improved by adding a small amount of Ag, in order to enhance fatigue resistance, a small addition gives less effect, and it is required to add Ag in an amount of nearly 1% by weight as in the case of SnAgCu-based alloy. Ni, Co and the like can strengthen a solder by precipitating fine intermetallic compounds solely in the solder or crystal grain boundary. The mechanism that a solder is strengthened by Ag is different, and the solder is strengthened by forming a three dimensional network where a needle-like intermetallic compounds Ag3Sn are arrayed in Sn. Accordingly, when an amount of Ag becomes to 1% by weight, since the network cannot be formed, and thus the solder cannot be strengthened.

Although by the addition of Bi, wettability is improved and creep property is also improved, toughness becomes lower because of the reduction of elongation to thereby decrease fatigue resistance.

Although by the addition of Ni, fatigue resistance can be improved, it is not sufficient, and furthermore, wettability becomes low.

Although by the addition of Si, it can be seen that fatigue resistance is improved slightly, it is completely insufficient and wettability becomes lower.

Furthermore, recently, a patent (cf. Patent document 1) has been disclosed in which, although in the case of a SnAgCu-based alloy, the constituent elements are the same as those of the present patent. According to the patent, both Cu erosion resistance and antioxidant property are obtained by adding small amounts of Co and Ge. This alloy is excellent in wettability and has relatively good fatigue resistance because Ag is contained from 1.0 to 5.0% by weight, but has drawbacks of containing expensive Ag in a large amount. Therefore, it is strongly desired to obtain a low-Ag solder having wettability and fatigue resistance of the same level as those of SnAgCu-based alloys.
[Patent document 1] Japanese Patent No. 3761182

Furthermore, a patent (cf. Patent document 2) has been disclosed in which 0.1 to 1.5% by weight of Cu, 0.01% by weight or more and less than 0.05% by weight of Co, 0.05 to 0.5% by weight of Ag, 0.01 to 0.1% by weight of Sb, and further 0.001 to 0.008% by weight of Ge are added.

The invention of the aforementioned Patent document 2 is to previously add Sb to SnCuCoAg, and further add Ge. According to the patent, Ge is added to inhibit oxidation, and Sb is added to inhibit the generation of dross like substance in the mentioned formulation range. The dross is produced when a solder is jet-flowed in a flow step, and is not necessary when the jet-flow is not required in a soldering step in the case of a solder paste and a resin-flux solder. In addition, conversely, there has been found an amazing fact that addition of Sb gives adverse effects on soldering properties and fatigue resistance. In addition, since the invention of the aforementioned Patent document 2 is composed of multi elements of 6 elements, there is a problem that quality control is not easy in the production of soldering materials.
[Patent document 2] Japanese Patent No. 4076182

Therefore, the trial of promoting the practical application by adding a small amount of elements to the conventional SnCu-based solder alloy to thereby improve long-term reliability typified by wettability and fatigue resistance has been still entirely insufficient.

### DISCLOSURE OF THE INVENTION

### Problems to be Solved by the Invention

Among them, the invention claimed in claim 1 has been made from such a viewpoint, and an object of the invention is to provide a low-silver lead-free solder alloy which is excellent in wettability, excellent in long-term reliability typified by fatigue resistance, and can compensate for the drawbacks of SnCu-based solder alloy

In addition, the inventions claimed in claims 2 and 3 are to provide a solder paste material and a resin-flux soldering material being excellent in fatigue resistance.

Further, the inventions claimed in claims 4 and 5 are to provide solder joined products which are excellent in fatigue resistance and prepared by using the solder paste material and the resin-flux soldering material.

### Means for Solving the Problems

As a result of the present inventors' intensive studies to accomplish the aforementioned objects, it has been found that when using a solder which contains 0.1 to 1.5% by weight of Cu, 0.01% by weight or more and less than 0.05% by weight of Co, 0.05 to 0.25% by weight of Ag, 0.001 to 0.008% by weight of Ge, and the remainder of Sn is a low-silver lead-free solder alloy that can have long-term reliability typified by excellent wettability and excellent heat cycle performance, which is an obstacle to the practical development of the aforementioned SnCu-based solder alloy, and the solder paste material or the resin-flux solder material produce remarkably significant fatigue resistance that can never be found in such a conventional alloy, and thus the present invention has been completed.

That is, among the present inventions, the lead-free solder alloy claimed in claim 1 comprises 0.1 to 1.5% by weight of Cu, 0.05 to 0.25% by weight of Ag, 0.01% by weight or more and less than 0.05% by weight of Co, 0.001 to 0.008% by weight of Ge, wherein the remainder is Sn.

Furthermore, the fatigue-resistant solder paste material claimed in claim 2 is characterized in that the lead-free solder alloy according to claim 1 is powdered, and then the powder and a liquid or pasty flux are admixed.

Moreover, the fatigue-resistant resin-flux solder material claimed in claim 3 is characterized in that the solder alloy according to claim 1 is molded in a liner form by using a solid or pasty flux as a core.

In addition, the fatigue-resistant joined product claimed in claim 4 is characterized in that the fatigue-resistant solder paste material according to claim 2 is used to thereby join a mounting material and a material to be mounted.

Furthermore, the fatigue resistant joined product claimed in claim 5 is characterized in that the fatigue-resistant resin-flux solder material according to claim 3 is used to thereby join a mounting material and a material to be mounted.

As mentioned above, through the addition of Co in an amount of 0.01% by weight or more and less than 0.05% by weight to a Sn-based lead-free solder alloy, the fatigue resistance of the solder is improved by, for example, forming in the interface of Cu of a substrate circuit and a solder, a uniform layer of intermetallic compounds of Sn—Cu, Sn—Co, Sn—Cu—Co which are difficult to grow up by heat load, and by producing and dispersing the highly strong and fine intermetallic compounds in the solder. In addition, introduction of Co can improve wettability of the solder due to the lowering of a surface tension of the solder.

However, when a content of Co becomes large, the intermetallic compounds of Sn—Cu, Sn—Co, Sn—Cu—Co are easily precipitated into the molten solder to form a dross, and when the content of Co is reduced to an extent that the dross is difficult to be formed, the creep performance and fatigue resistance become insufficient.

The addition of Ag improves wettability to thereby inhibit soldering failure, and also contribute to fatigue resistance.

To this SnCu-based solder alloy containing small amounts of Co and Ag, the most characteristic feature of the present invention is to add further a small amount of Ge. When Co and Ge coexist, elongation of the solder is extremely increased to thereby withstand deformation because of heat stress load, and thus, fatigue resistance can be improved. This effect is not produced, not only when Co or Ge is added solely to the SnCuAg-based solder and when an other element such as Bi, Ni or In is added, but also the effect is not produced when Co and Ge coexist in the SnAgCu-based solder containing a large content of Ag.

The invention according to Patent No. 3761182 is one in which Ag is added by 4 times or more the present invention. The reason why fatigue resistance is inferior to the present invention despite of a large amount of Ag, is estimated to be bad compatibility of Co and Ag. When adding Co to the SnCu-based or the low Ag-based solder, a zero-crossing time which is an index of wettability becomes shorter, but when adding Co to the SnAgCu-based solder containing a large amount of Ag, a zero-crossing time becomes inversely longer. Moreover, elongation according to tensile test is the same behavior, and when adding Co to the SnCu-based or the low Ag-based solder, elongation becomes large, but when adding Co to the SnAgCu-based solder containing a large Ag, elongation becomes inversely small. As described above, since, when an amount of Ag is large, the effect of the addition of Ag and Co is offset by the addition of Co and thus, even when Co or Ge is added to the SnAgCu-based solder containing a large amount of Ag, the wettability and fatigue resistance cannot be improved enough to be expected.

The invention according to Patent No. 4076182 is a patent in which a small amount of Sb is further added to the present invention. It has been newly found that, as mentioned before, since this is to inhibit the formation of dross when jet-flowing a molten solder in flow, not only this is unnecessary for applications such as solder-paste and resin-flux solder in which jet-flow is not applied during the soldering step, but also this gives adverse effects for improvement of wettability and fatigue resistance.

The reason why Sb suppresses dross formation in jet-flow is to prevent the formation and aggregation of intermetallic compound which forms core of dross in molten solder. Therefore when fine intermetallic compounds are produced in jet-flowed solder, they exist stably. As a result, it has been found that when soldering is carried out, the intermetallic compound adheres to Cu in the substrate to be soldered, or to iron of a tip of soldering iron to thereby inhibit the formation of interface layer. Because of this, it has been found that the addition of Sb accelerates Cu erosion and Fe erosion, and inhibits strengthening of the interface by precipitating the intermetallic compound on the interface between Cu to form a uniform layer, which is one of conditions of improving fatigue resistance.

In addition, since Sb does not have an effect of improving wettability by lowering a surface tension of solder such as Bi and Co, but, conversely, decreases wettability somewhat, it has been found preferable that Sb may not be added to a solder paste and resin-flux solder which are not subjected to jet-flow during soldering.

### Effect of the Invention

As mentioned above, a low-silver solder alloy having excellent wettability and heat cycle properties can be prepared by adding Co and Ge at the same time to the predetermined formulated SnCuAg-based alloy. The low-silver solder alloy is considered to be unfavorable when flowing in the form of the jet-flow because of dross formation, but gives unexpected effects by which a joined product having remarkably improved wettability and fatigue resistance can be obtained when being produced in the form of a solder-paste material or resin-flux soldering material.

### BEST MODES FOR CARRYING OUT THE INVENTION

The embodiments according to the present invention will be explained in the following.

The range of the content of Cu according to the present invention is a range of 0.1 to 1.5% by weight. When Cu is less than 0.1% by weight, erosion resistance of Cu and wettability are inferior, and when Cu is more than 1.5% by weight, a melting point becomes high, and thus there occurs a soldering defect such as needle-like projection in soldering work.

By containing Co in an amount of 0.01% by weight or more and less than 0.05% by weight, a layer of the intermetallic compounds of Sn—Cu, Sn—Co, Sn—Cu—Co to be formed in the soldering interface is formed parallel to the soldering surface and relatively thick. Since this layer is difficult to grow up by heat load or load of thermal change, and it disperses into a solder and is precipitated to make the solder strong, long-term reliability typified by fatigue resistance can be improved.

When the content of Co is less than 0.01% by weight, since the thickness of the intermetallic compounds formed on the interface is thin, it is insufficient to make the interface strong, and when the content of Co is 0.05% by weight or more, the thickness of the intermetallic layer, conversely, becomes too tick and a hardness of the solder becomes high, which results in lowering toughness, and thus fatigue resistance is not improved. In addition, when Ag, Cu, Ge coexist, dross may be formed easily, resulting in the occurrence of soldering defects including needle-like projection and joint failure.

The addition of Ag improves wettability, and also contributes to the improvement of fatigue resistance. These effects are not exhibited when the content of Ag is less than 0.05% by weight, and when the content of Ag is more than 0.25% by weight and Co and Ge coexist, a dross is likely to be formed in the solder, resulting in the occurrence of soldering defects including needle-like projection and joint failure.

The addition of Ge not only inhibits the generation of oxides, but also it is effective for improving long-term reliability typified by wettability and fatigue resistance. Moreover, when this Ge coexists with Co in the solder alloy, elongation becomes extremely large, and thus fatigue resistance is further improved. This remarkably large elongation cannot be obtained by sole addition of Co or Ge, and this phenomenon cannot be observed by addition of other metals, and also cannot be found in the case where Co and Ge are added to the SnAgCu-based alloy having a large amount of Ag. The effect of the addition to the Co-added solder alloy cannot be produced in an amount of less than 0.001% by weight. When the addition amount is more than 0.008% by weight, in the case where Cu, Ag, Co coexist, the intermetallic compounds are precipitated in the form of a dross at a soldering temperature near the melting point to thereby prevent soldering.

From the lead-free solder alloy produced by the aforementioned manners, the fatigue-resistant solder paste material and the resin-flux solder material of the present invention can be produced according to known methods. That is, the solder paste material described above can be produced by powdering the aforementioned lead-free solder alloy, and admixing the powder with a known liquid or pasty flux which is used for such an object like this. The resin-flux solder material can be produced by molding the aforementioned solder alloy in a liner form by using a solid or pasty flux as a core according to the known method.

A mounting material and material to be mounted by using the aforementioned solder materials are preferably a mounting material and material to be mounted used for metal joining of electric and electronic devices.

### Examples

Solders of 5 kg of Examples (No. 1 to No. 2) and Comparative Examples (No. 1 to No. 4) having compositions of the TABLE 1 mentioned below were prepared by melting the given metals at 450° C., sufficiently stirring, and then lowering the temperature of molten liquid to 350° C. to thereby be cast into a die of 50° C. At this time, in consideration of the fact that only Ge is easy to be oxidized, Ge is finally added at the time of lowering the temperature of the molten liquid to 350° C., and then resultant product was sufficiently stirred. Furthermore, solder powder of 2 kg having a particle size of 20 μm to 38 μm was prepared by using the solder prepared in the same steps, as a raw material. Moreover, this solder powder was mixed with a RMA-type pasty flux to prepare a solder paste.

It should be noted that Sn0.1Ag0.7Cu0.03Co0.005Ge (EXAMPLE) means a solder alloy of 0.1% by weight of Ag, 0.7% by weight of Cu, 0.03% by weight of Co, 0.005% by weight of Ge, and reminder being Sn.

With respect to the thus obtained solders, zero-crossing time (sec), strength (N/mm²) and elongation (%) were measured. Furthermore, with respect to the substrates which were soldered by the prepared solder pastes, thermal-fatigue testing was conducted, and then the joint strength of chip resistor after the testing was determined. The testing procedures were as follows.

A zero-crossing time was measured by using a copper plate of 5×50×0.3 mm with wettability-testing machine under the conditions of immersion depth of 2 mm, immersion speed of 2.5 mm/sec. and immersion period of 10 sec. It should be noted that the test temperature was set to a liquidus temperature +35° C., and a RMA type flux was used.

### [Tensile Strength (N/mm²)], Elongation (%)]

Two ingots were prepared through casting by using a solder of 1.5 kg at a temperature of molten liquid of 350° C., a die temperature of 50° C. From these ingots, two test pieces of JIS 4 were prepared through mechanical processing. With respect to the test pieces, tensile testing was conducted under the conditions of a stain rate of 30%/min. at a room temperature.

### [Joint Strength of Chip Resistor]

A chip resistor (2012) was reflow-soldered on a test substrate by using a solder paste prepared from a predetermined solder alloy powder and a flux. At that time, the temperature of reflow peek was set to a melting point (liquidus temperature) of the solder alloy +20° C. In order to measure the thermal fatigue property of the prepared substrate, thermal change of from −40° C. to +125° C. was applied. The substrate was maintained for 30 minutes at each temperature, the test was carried out to 1500 cycles. To the chip resistor on the substrate after the testing, a load was applied from the lateral direction, and strength when the part was peeled off from the substrate was measured.

Furthermore, the part was embedded into a resin together with the substrate, the sectional view of the joint part of the solder after abrasion was observed to thereby check the existence of cracks.

TABLE 1

| Solder to be tested | Sn | Ag | Cu | Co | Sb | Ge |
|---|---|---|---|---|---|---|
| EXAMPLE 1 | Reminder | 0.1 | 0.7 | 0.03 | | 0.005 |
| EXAMPLE 2 | Reminder | 0.2 | 0.8 | 0.04 | | 0.003 |
| COMPARATIVE | Reminder | 0.3 | 0.7 | | | |
| EXAMPLE 1 | | | | | | |
| COMPARATIVE | Reminder | 3.0 | 0.5 | 0.02 | | 0.010 |
| EXAMPLE 2 | | | | | | |
| COMPARATIVE | Reminder | 0.1 | 0.7 | | | 0.010 |
| EXAMPLE 3 | | | | | | |
| COMPARATIVE | Reminder | 0.3 | 0.7 | 0.03 | 0.03 | 0.007 |
| EXAMPLE 4 | | | | | | |

The numerals in TABLE 1 are % by weight.

TABLE 2

| | | | | Fatigue-resistance test | | |
|---|---|---|---|---|---|---|
| | | | | Joint Strength | | Clack |
| | Zero- | Tensile Test | | of Chip | | in |
| | crossing | Tensile | | Resistor (N) | | section |
| Solder to be | time | strength | Elongation | Initial | 1500 | 15000 |
| tested | (sec.) | (N/mm²) | (%) | value | cycles | cycles |
| Example 1 | 0.74 | 33.8 | 75.4 | 55.8 | 30.9 | None |
| Example 2 | 0.72 | 34.3 | 73.8 | 54.6 | 30.0 | None |
| Comparative | 1.04 | 33.5 | 35.4 | 40.2 | 16.0 | Found |
| Example 1 | | | | | | Large |
| Comparative | 0.68 | 46.7 | 32.5 | 56.0 | 31.2 | Found |
| Example 2 | | | | | | Small |
| Comparative | 0.78 | 33.7 | 52.5 | 45.3 | 22.3 | Found |
| Example 3 | | | | | | Medium |
| Comparative | 0.77 | 33.9 | 64.3 | 52.0 | 28.0 | Found |
| Example 4 | | | | | | Small |

As is evident from the aforementioned results, the zero-crossing times of solder alloy of Examples 1 and 2 are 0.72 to 0.74 sec., but in comparative example, though Comparative Example 2 gives 0.68 sec., Comparative Examples 1, 3, and 4 give 0.77 to 1.04 sec. The elongation of Examples 1 and 2 in the tensile test are 73.8 to 75.4%, but Comparative Examples 1 to 4 give 32.5 to 64.3%. As an example, FIG. 1 shows the appearance photographs of Example 1 and Comparative Example 2 after the tensile testing. Furthermore, the joint strengths of chip resistor of Examples 1 and 2 after testing at 1500 cycles are 30.0 to 30.9 N, but in comparative example, although Comparative Example 2 gives 31.2 N, Comparative Examples 1, 3, and 4 give 16.0 to 28.0 N. The cracks of solder after testing at 1500 cycles did not occur in each of Example 1 to 2, but the cracks were observed in each of Comparative Examples 1 to 3. As an example, FIG. 2 shows the cross-sectional view of Example 1 and Comparative Example 2 after testing at 1500 cycles. These results show that, by adding Co and Ge to a low Ag-based SnCuAg solder alloy at the same time, wettability is improved, and elongation becomes extremely large. As a result, the resultant alloy has excellent heat cycle property being superior to a high Ag-based SnAgCu, and no crack occurs in the solder even after testing at 1500 cycles of thermal change, which gives excellent joint reliability.

The solder of Comparative Example 2 which is constituted by the same elements as those of the present invention exhibits, in comparison with the other Comparative Examples, a short zero-crossing time and a large chip strength at 1500 cycles. However, since the elongation is as low as 32.5 which results in lowering toughness and fatigue resistance. In addition, since Ag content is high, the objects of the present invention have not been fulfilled, and furthermore, the objects of the present invention have never been satisfied since the slight cracks are observed in the joint portion at 1500 cycles.

The solder of Comparative Example 4 which has been prepared by adding Sb to the solder of the present invention has a short zero-crossing time in comparison with Comparative Examples 1 and 3. Furthermore, the chip joint strength at 1500 cycles and elongation are somewhat inferior to those of Examples 1 and 2. In addition, in comparison with Examples 1 and 2, since the small cracks have been observed in the joint portion at 1500 cycles, the objects of the present invention have never been satisfied.

FIG. 1 shows the test piece of JIS 4 before the testing and the test pieces of Example 1 and Comparative Example 2 after the testing. The test piece after the testing of Example 1 shows a larger elongation in the tensile test in comparison with the test piece after the testing of Comparative Example 2. Moreover, the unevenness of the surface is small, which shows that the crystalline structure of the solder is fine.

FIG. 2 shows the cross-sectional view of the chip resistors of Example 1 and Comparative Example 2 before the testing and after the fatigue-resistant testing at 1500 cycles. Cracks occur in the solder of Comparative Example 2, but any crack does not occur in Example 1.

It has been confirmed that the resin-flux solder materials prepared by using the lead-free solder alloy of the Examples 1 and 2 exhibit the same results as the aforementioned results through the identical testing.

### BRIEF EXPLANATION OF DRAWINGS

FIG. 1 shows the appearance photographs of the tensile test piece before testing and the test pieces of Example 1 and Comparative Example 2 after the tensile testing.

FIG. 2 shows cross-sectional views of chip resistors of Example 1 and Comparative example 2 before and after 1500 cycle.

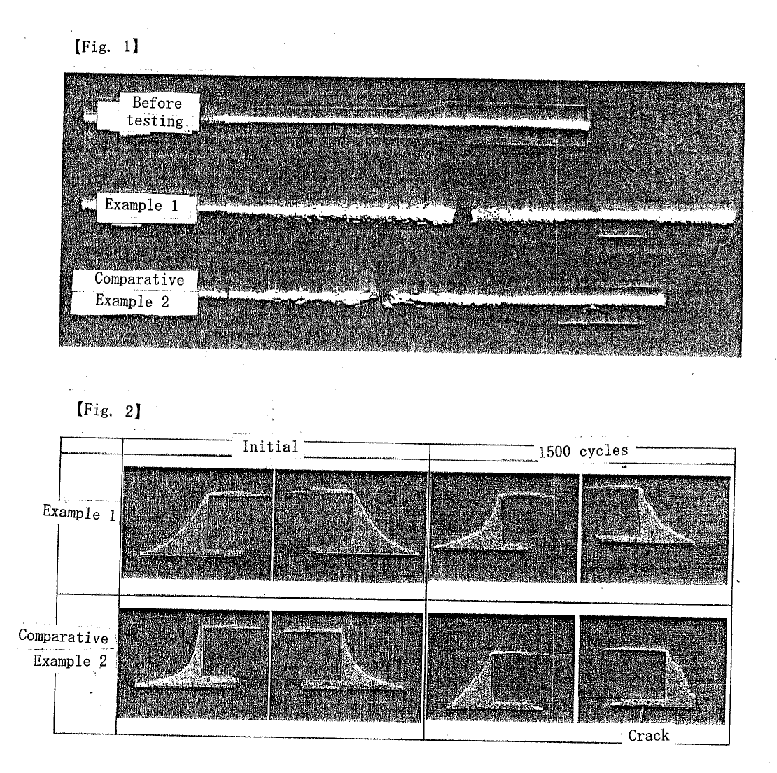

1. A lead-free solder alloy comprising 0.1 to 1.5% by weight of Cu, 0.01% by weight or more and less than 0.05% by weight of Co, 0.05 to 0.25% by weight of Ag, 0.001 to 0.008% by weight of Ge, wherein remainder is Sn.

2. A fatigue-resistant solder paste material, wherein the lead-free solder alloy according to claim 1 is powdered, and then the powder and a liquid or pasty flux are admixed.

3. A fatigue-resistant resin-flux solder material, wherein the solder alloy according to claim 1 is molded in a liner form by using a solid or pasty flux as a core.

4. A joined product, wherein the fatigue-resistant solder paste material according to claim 2 is used to thereby join a mounting material and a material to be mounted.

5. A joined product, wherein the fatigue-resistant resin-flux solder material according to claim 3 is used to thereby join a mounting material and a material to be mounted.
